(19) United States
(12) Patent Application Publication
(10) Pub. No.: US 2003/0223504 A1
(43) Pub. Date: Dec. 4, 2003

(54) Memory-based digital adaptive filter

(76) Inventors: Huimin Chen, Folsom, CA (US); James Little, Sacramento, CA (US); Scott Chiu, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/163,200

(22) Filed: Jun. 4, 2002

(51) Int. Cl. H04K 1/10

(52) U.S. Cl. 375/260

(57) ABSTRACT

One embodiment of the invention provides a method, system, and apparatus to update an adaptive filter real-time based on pre-determined filter configurations. When it is determined that an adaptive filter should be updated, a request is made for an updated filter configuration. An updated filter configuration is provided from a storage device that stores multiple pre-determined filter configurations for various operating conditions.

### FIELD

Various embodiments of the invention pertain, generally, to adaptive filters for communications. More particularly, at least one embodiment of the invention relates to a digital adaptive filter that is adapted based on pre-stored coefficients.

### BACKGROUND

Digital filters are typically employed along transmit and/or receive channels to achieve optimal operating conditions. Digital signal processor (DSP) based transceiver designs often employ a large number of digital filters for various purposes, such as line equalization, pre-equalization transmit-pulse shaping, inter-symbol interference cancellation, and echo cancellation for instance.

Typically, adaptive filters are adjusted real-time or as needed based on communication, signal, and/or operating conditions to obtained a desired effect (e.g., improving signal quality). Generally, filter adaptation involves modifying or adjusting filter coefficients or weights.

Conventional digital filters typically include a multiplier-accumulator component (MAC) or an on-chip processing unit to carry out filter coefficient updates. The use of either a MAC or processing unit has several disadvantages including, hardware overhead, extra power consumption, and a relatively low update speed where an on-chip processor is used.

### BRIEF DESCRIPTION OF THE DRAWINGS

FIG. 1 is a flow diagram illustrating the adaptation of a communication filter based on pre-stored configurations according to one implementation of the invention.

FIG. 2 is a block diagram illustrating a memory-based digital adaptive filter according to one embodiment of the invention.

FIG. 3 is a flow diagram illustrating the general operation of a communication filter according to one embodiment of the invention.

FIG. 4 is a block diagram illustrating a memory-based digital adaptive filter where an adaptation, optimization, and detector unit is employed according to one embodiment of the invention.

FIG. 5 is a block diagram illustrating a communication filter that may be employed in an embodiment of the invention.

FIG. 6 is a block diagram illustrating yet another communication filter according to one embodiment of the invention.

FIG. 7 is a flow diagram illustrating the general operation of a controller according to one embodiment of the invention.

FIG. 8 is a block diagram illustrating a memory-based digital adaptive filter architecture for a multi-channel transceiver according to one embodiment of the invention.

### DETAILED DESCRIPTION

In the following detailed description of various embodiments of the invention, numerous specific details are set forth in order to provide a thorough understanding of various aspects of one or more embodiments of the invention. However, one or more embodiments of the invention may be practiced without these specific details. In other instances, well known methods, procedures, and/or components have not been described in detail so as not to unnecessarily obscure aspects of embodiments of the invention.

In the following description, certain terminology is used to describe certain features of one or more embodiments of the invention. For instance, the term ‘filter’ includes any electronic device that modifies a signal and/or communication channel. Also, the term ‘filter configuration’ includes filter coefficients and/or weights. The term ‘adapt’ (e.g., filter adaptation) is hereinafter used interchangeably with such terms as ‘modify’, ‘update’, and ‘reconfigure’. The term ‘pre-calculated’ (e.g., pre-calculated configuration) is hereinafter used interchangeably with such terms as ‘predetermined’, ‘pre-defined’ and ‘pre-stored’.

One aspect of an embodiment of the invention provides a system, device, and method to adapt communication filters using pre-stored filter configurations.

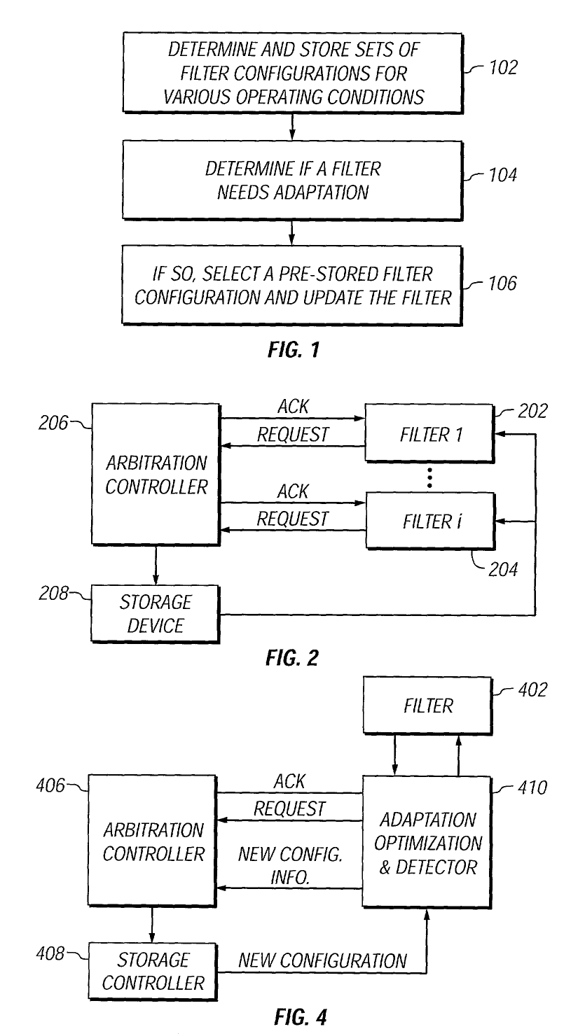

FIG. 1 is a flow diagram illustrating one implementation of the invention to adapt a communication filter based on pre-stored configurations. Filter configurations, such as weights or coefficients, for various operating conditions are determined and stored 102. That is, for different operating conditions, such as signal degradation, echo, etc., a particular configuration (e.g., coefficients) is selected and stored for the filter. The filter, signal, or some signal metric is monitored during operation to determine if it needs adaptation 104. For example, the signal energy or power level of the input signal to the filter and/or output signal from the filter may be monitored to determine if the filter should be adapted or reconfigured to improve the signal quality. If it is determined that the filter should be adapted, then a pre-stored configuration (e.g., filter coefficients or weights) is selected and the filter is updated 106.

FIG. 2 is a block diagram illustrating one embodiment of a memory-based digital adaptive filter. One or more adaptive filters 202 and 204 are communicatively coupled to an arbitration controller 206 and a storage device 208. The adaptive filters 202 and 204 may be transmitter filters, receiver filters, or a combination thereof, and serve to improve communications and/or signal quality from an input signal to an output signal (not illustrated). The filter 202 or 204 sends a request to the arbitration controller 206 for a new filter configuration. The arbitration controller 206 serves to receive configuration update requests from one or more filters 202 or 204 and process such requests. The arbitration controller 206 retrieves the requested configuration from the storage device 208 and provides it to the requesting filter.

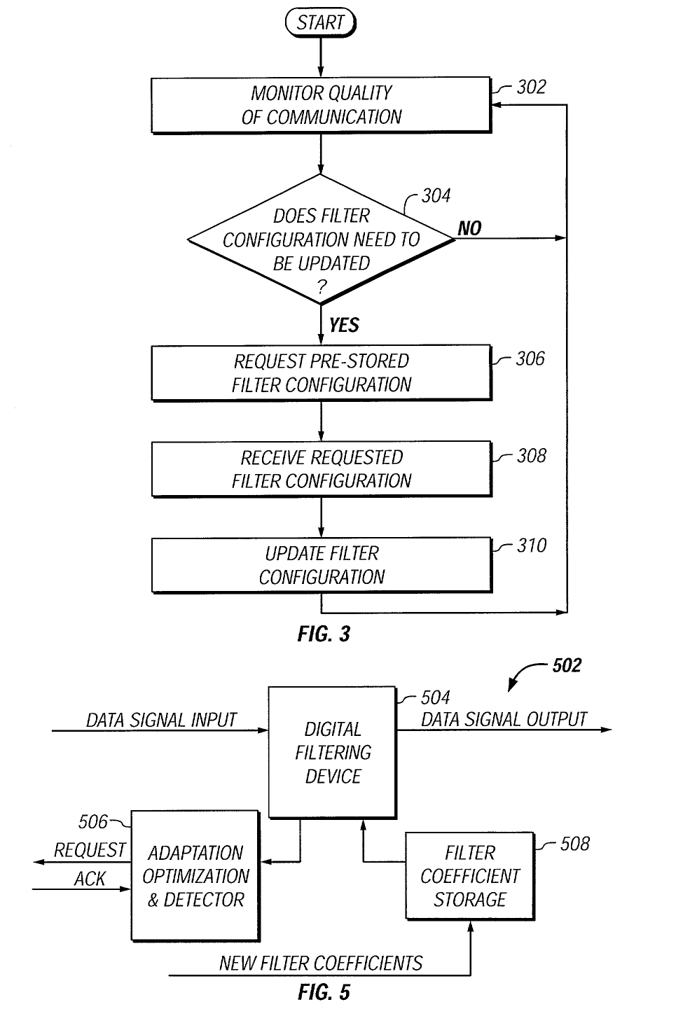

FIG. 3 is a flow diagram illustrating the general operation of a communication filter according to one embodiment of the invention. The quality, characteristics, metrics, and/or properties of a signal or communication are monitored 302. Based on this information, a determination is made as to whether the signal or communication reception and/or transmission should be improved by employing a different filter configuration 304 (e.g., adapting the filter to respond to the operating conditions). If a different filter configuration is desired, a request is made to update the filter configuration (e.g., new filter coefficients are requested). Upon receiving a new filter configuration 308 (e.g., updated filter coefficients), the filter is updated using this new configuration 310.

Monitoring of the quality of communications or signal may be implemented in several ways without departing from the invention. For example, the power or energy level of the input and/or output signal through a filter 202 or 204 may be monitored to determine if the adaptive filter 202 or 204 should be adapted. For instance, if the signal power across the filter diminishes below a threshold level or below a noise-to-signal ratio, the filter may be adapted to improve this condition.

The monitoring of the communication and/or signal of interest may be implemented in a number of ways without departing from the invention. FIG. 4 is a block diagram illustrating a memory-based digital adaptive filter where an adaptation, optimization, and detector unit 410 is employed according to one embodiment of the invention. In this embodiment of the invention, the adaptation, optimization, and detector unit 410 serves to monitor the operation of the filter (or signal through the filter 402) and adapt the filter accordingly. If the unit 410 determines that a new filter configuration would be desirable, it requests such configuration. The unit 410 may also provide some information about the new configuration desired (e.g., the particular filter configuration sought or the direction in which the filter should be reconfigured). For example, the filter configuration update request may merely indicate the direction in which the filter configuration should be improved relative to its current configuration. Thus, the filter configuration may be iteratively improved until a desired filter operation is achieved.

Once the requested new configuration is received, the unit 410 updates the filter 402 based on this new configuration (e.g., new filter coefficients).

In various implementations of the invention, a single adaptation, optimization, and detector unit 410 serves a single adaptive filter 402, while in other embodiments of the invention a single unit 410 serves multiple adaptive filters.

FIG. 5 is a block diagram illustrating a communication filter 502 according to an embodiment of the invention. A digital filtering device or unit 504 serves to receive a data signal input and provide a data signal output. Rather than employing an external and separate adaptation, optimization, and detector unit (as illustrated in FIG. 4), each filter 502 may include an adaptation, optimization, and detector unit 506. Like the unit 410 described above, the unit 506 serves to monitor or detect the operation of the digital filtering device 504, determine a desired operating configuration, and request a new, desired, and/or updated filter configuration. In this example, the new filter configuration includes filter coefficients that are stored in a filter coefficient storage device 508. The digital filtering device 504 is updated or adapted based on these filter coefficients.

There are numerous ways in which the filter-controller interface may be implemented without departing from the invention. In one implementation, a request is sent from the filter (e.g., 402 in FIG. 4) to the controller (e.g., 406) for a new configuration, and an acknowledgement (ack) reply is sent from the controller (e.g., 406) to the requesting filter (e.g., 402) to notify the filter (e.g., 402) that the new configuration has been sent.

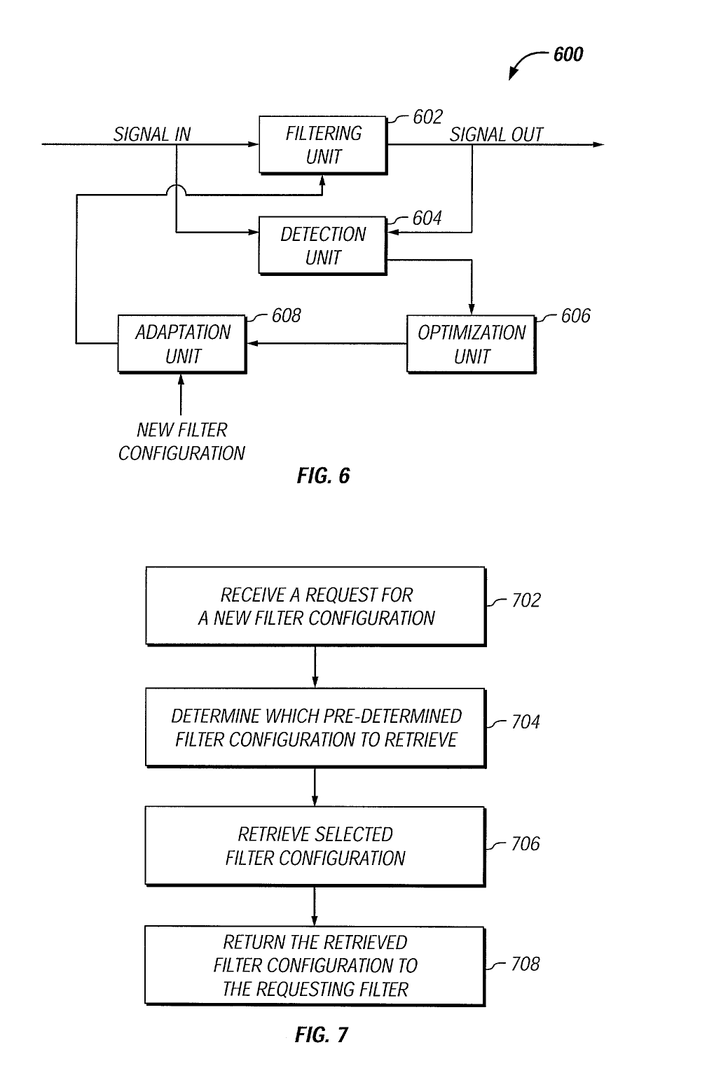

FIG. 6 is a block diagram illustrating yet another embodiment of a communication filter according to one embodiment of the invention. An adaptable (configurable) filtering unit 602 receives an input signal and provides an output signal. The filtering unit may change or alter the input signal (e.g., echo cancellation, inter-symbol cancellation, transmit pulse shaping, etc.) and/or transmission channel characteristics (e.g., termination impedance, etc.). A detection unit 604 monitors one or more characteristic of the signal, such as energy or power level, noise level, etc. Based on information provided by the detection unit 604, an optimization unit 606 determines whether the filtering unit's 602 configuration (e.g., filtering coefficients) should be updated to improve or change the signal and/or communication channel in some way. If it is determined that the filtering unit 602 should be modified, then an adaptation unit 608 retrieves a precalculated filter configuration and updates the filtering unit 602.

FIG. 7 is a flow diagram illustrating the general operation of a controller according to one embodiment of the invention. An arbitration control (e.g., 206 in FIG. 2 or 406 in FIG. 4) receives a request for a new filter configuration (e.g., new filter coefficients) 702. In one implementation of the invention, the arbitration controller (e.g., 206 or 306) merely processes update requests on a first in first out basis. In other implementations of the invention, the arbitration controller receives interrupt requests from the one or more filters and prioritizes processing of said requests based on some criteria (e.g., the filter with a higher priority is serviced first).

After receiving an update request, the controller determines which stored filter configuration (e.g., coefficients) should be retrieved 704. The controller may simply employ information provided by the requesting filter to retrieve a new filter configuration. For example, the requesting filter may provide information about the new filter configuration sought or the way in which the filter should be adapted. In one implementation of the invention, the controller is provided with the information identifying the actual filter configuration sought (e.g., identifying a particular set of pre-stored filter coefficients).

A new filter configuration is then retrieved and 706 and provided to the requesting filter 708.

In various implementations of the invention, the filter configurations (e.g., filter coefficients or weights) may be stored in a number of ways and devices without departing from the implementations of the invention. For example, the filter configurations for various communication and/or operating conditions may be calculated and stored in a memory device (e.g., 208 in FIG. 2 or 408 in FIG. 4). In one implementation of the invention, the filter configurations may are pre-calculated and pre-stored in the memory device, for example, the filter configurations are calculated and stored at start-up or periodically. In some implementations of the invention, the filter configurations may be programmable, for instance a transmitter pulse template may be programmable for different applications.

The storage device may include any one of a number of devices without departing from the invention. For example, in one embodiment of the invention, a read-only storage device (e.g., ROM), containing previously determined or pre-calculated filter configurations (e.g., coefficients), is employed. In other implementations of the invention, a read/write storage device (e.g., random access memory RAM) is employed and the filter configurations are pre-programmed at startup or updated as regularly, periodically, or as needed.

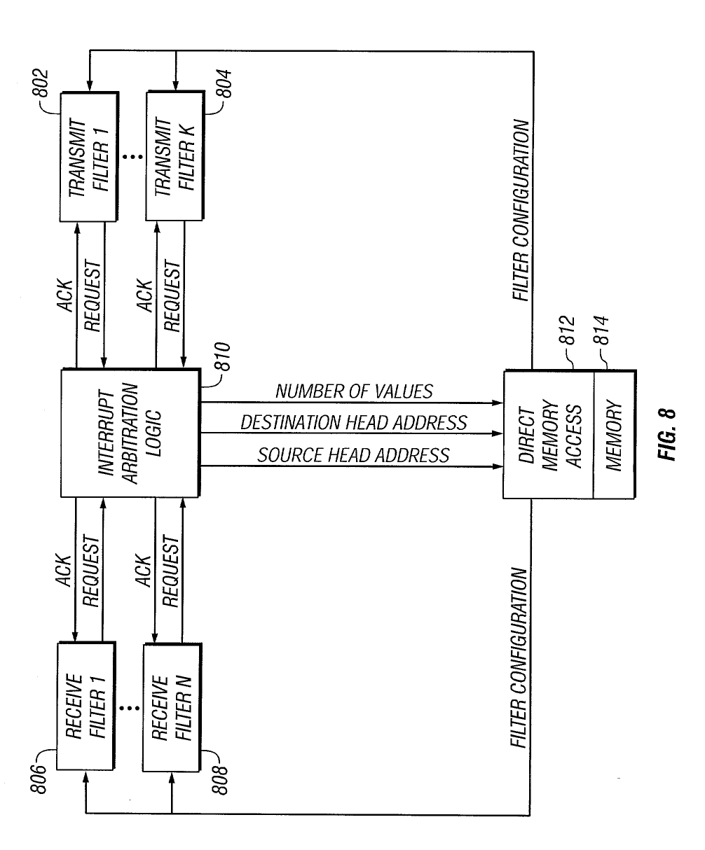

FIG. 8 is a block diagram illustrating a memory-based digital adaptive filter architecture for a multi-channel transceiver according to one embodiment of the invention. Multiple transmit channel filters 802 and 804 along with multiple receive channel filters 806 and 808 are communicatively coupled to interrupt arbitration logic 810. Each adaptive filter 802, 804, 806, or 808, is configured to request an updated filter configuration when it is determined that the filter should be adapted. All of the requests are handled by the interrupt arbitration logic which prioritizes the requests and processes competing requests according to their priority level (e.g., receive versus transmit filter, filter priority, etc.). When no other request is being serviced, the arbitration logic processes the current request. Otherwise, it may queue the request(s) for subsequent processing.

The interrupt arbitration logic 810 is provided with information about which filter configuration to retrieve from the storage device 814. For instance, in the example illustrated in FIG. 8, the filter provides the source head address, destination head address, and a count of the values to be transferred. The source head address indicates the starting location of the filter configuration (e.g., filter coefficients or weights) desired. The destination head address indicates the location of where to copy the retrieved values (e.g., a register associated with the requesting filter).

A direct memory access unit 812 may be employed to map a memory storage device. For example, the direct memory access unit 812 may receive three inputs, source head address, destination head address, and a count of the values to be transferred, which it uses to retrieve the requested filter configuration from memory storage 814. The retrieved filter configuration may be copied to a register from where the requesting filter may be updated.

After the requested updated filter configuration is retrieved, an acknowledgement (ack) is generated indicating that the interrupt request has been processed. In one implementation of the invention, the interrupt request is processed so that the filter configuration is updated real-time or substantially in real-time. On one embodiment of the invention, the requesting filter is updated at least as fast, or faster than, as if the new filter configuration had be calculated real-time.

While certain exemplary embodiments of the invention have been described and shown in the accompanying drawings, it is to be understood that such embodiments of the invention are merely illustrative of and not restrictive on the broad aspects of various embodiments of the invention, and that these embodiments of the invention not be limited to the specific constructions and arrangements shown and described, since various other modifications are possible. For instance, while aspects of the invention have been illustrated for a digital communication filter, these aspects of the invention may be readily implemented in other electrical and/or electronic devices without departing from the invention. Additionally, it is possible to implement the embodiments of the invention or some of their features in hardware, programmable devices, firmware, or a combination thereof.

What is claimed is:

1. A method comprising:
determining whether a communication filter should be adapted; and
adapting the communication filter using a filter configuration from among multiple pre-determined filter configurations.

2. The method of claim 1 wherein determining whether the communication filter should be adapted comprises
monitoring one or more characteristics of a communication signal, and
determining if the one or more characteristics are beyond desired thresholds.

3. The method of claim 1 further comprising:
storing multiple communication pre-determined filter configurations.

4. The method of claim 1 wherein the multiple communication filter configurations provide different filter operating characteristics.

5. The method of claim 1 further comprising:
retrieving the pre-calculated filter configuration, from among the multiple stored filter configurations, if it is determined that the filter should be adapted.

6. The method of claim 1 wherein the filter configuration includes filter coefficients.

7. The method of claim 1 further comprising:
generating an interrupt request if it is determined that the filter should be adapted.

8. The method of claim 7 further comprising:
arbitrating between two or more interrupt requests from different adaptive filters.

9. The method of claim 8 wherein arbitrating between two or more interrupt requests includes,
determining the priority level of each request, and
processing the request with the highest priority first.

10. A device comprising:
an adaptive filter to filter a signal and request an updated filter configuration;
a controller coupled to the adaptive filter, the controller to process update requests from the adaptive filter; and
a storage device coupled to the controller, the storage device to store one or more pre-determined filter configurations and provide the one or more pre-determined filter configurations to the adaptive filter upon request.

11. The device of claim 10 further comprising:
a detector configured to detect one or more characteristics of the signal being filtered and determine if the filter should be adapted in response to one or more signal characteristics detected.

12. The device of claim 10 wherein the filter is configured to perform line equalization.

13. The device of claim 10 wherein the filter is configured to perform echo cancellation.

14. The device of claim 10 wherein the filter is configured to perform inter-symbol interference cancellation.

15. The device of claim 10 wherein the filter is configured to perform transmit-pulse shaping.

16. The device of claim 10 wherein the controller is an arbitration controller configured to arbitrate between competing update requests from two or more filters.

17. The device of claim 10 further comprising:
an optimization unit coupled to the filter, the optimization unit configured to monitor the signal and request an updated filter configuration if it is determined that one or more signal characteristics should be changed.

18. The device of claim 17 wherein the optimization unit is further configured to reconfigure the filter based on the updated filter configuration.

19. The device of claim 10 wherein the adaptive filter is updated in real-time.

20. The device of claim 10 wherein a filter configuration includes one or more filter coefficients.

21. A device comprising:
filtering means for filtering a signal and requesting an updated filter configuration;
control means for processing update requests from the filtering means, the control means being coupled to the filtering means; and
storage means for storing one or more pre-determined filter configurations and providing them to the filtering means upon request, the storage means being coupled to the control means.

22. The device of claim 21 further comprising:
means for detecting one or more characteristics of the signal being filtered and determining if the filtering means should be adapted in response to one or more signal characteristics detected, the detection means being coupled to the filtering means.

23. The device of claim 21 wherein the control means is configured to arbitrate between competing update requests from two or more filters.

24. The device of claim 21 further comprising:
optimizing means for monitoring the signal and requesting an updated filter configuration if it is determined that one or more signal characteristics should be changed, the optimizing means being coupled to the filtering means.

25. The device of claim 24 wherein the optimizing means is further configured for adapting the filtering means based on the updated filter configuration.

26. The device of claim 21 wherein the filtering means is updated in substantially real-time.

27. The device of claim 21 wherein a filter configuration includes one or more filter coefficients.

28. An adaptive communication filter comprising:
a filtering unit to filter a signal;
a detection unit to monitor one or more signal characteristics; and
an adaptation unit coupled to the detection unit and the filtering unit, the adaptation unit to retrieve a pre-calculated filter configuration and update the filtering unit if the one or more signal characteristics monitored are beyond a desired threshold.

29. The adaptive communication filter of claim 28 further comprising:
an optimization unit coupled to the detection unit, the optimization unit to determine whether the filtering unit should be updated based on the one or more signal characteristics monitored.

30. The adaptive communication filter of claim 28 wherein the filtering unit is configured to filter digital signals.
